(19) United States
(12) Patent Application Publication
(10) Pub. No.: US 2010/0272982 A1
(43) Pub. Date: Oct. 28, 2010

(54) THERMAL SPRAY COATINGS FOR SEMICONDUCTOR APPLICATIONS

(76) Inventors: Graeme Dickinson, Scottsdale, AZ (US); John Sirman, Bethlehem, CT (US); Adil Ashary, Zionsville, IN (US); Christopher Petorak, Chandler, AZ (US); Neill Jean McDill, Scottsdale, AZ (US)

Correspondence Address: PRAXAIR, INC.;LAW DEPARTMENT - M1 557, 39 OLD RIDGEBURY ROAD, DANBURY, CT, 06810-5113, US

(21) Appl. No.: 12/582,237

(22) Filed: Oct. 20, 2009

Related U.S. Application Data
(60) Provisional application No. 61/111,119, filed on Nov. 4, 2008.

(51) Int. Cl. B32B 3/26; B32B 18/00; B32B 15/04; B05D 1/08; C09D 5/08

(52) U.S. Cl. 428/304.4; 428/446; 428/450; 428/457; 428/698; 205/50; 428/702; 428/472; 427/446; 106/14.05

(57) ABSTRACT

This invention relates to thermal spray coatings on a metal or non-metal substrate. The thermal spray coating comprises a partially or fully stabilized ceramic coating, e.g., yttria stabilized zirconia coating, and has sufficiently high thermodynamic phase stability to provide corrosion and/or erosion resistance to the substrate. This invention also relates to methods of protecting metal and non-metal substrates by applying the thermal spray coatings. The coatings are useful, for example, in the protection of integrated circuit manufacturing equipment, internal chamber components, and electrostatic chuck manufacture.

### RELATED APPLICATIONS

This application claims the benefit of U.S. Provisional Application Ser. No. 61/111,119, filed on Nov. 4, 2008, which is incorporated herein by reference.

### FIELD OF THE INVENTION

This invention relates to thermal spray coatings for use in harsh conditions, e.g., coatings that provide erosive and corrosive barrier protection in harsh environments such as plasma treating vessels that are used in semiconductor device manufacture. In particular, it relates to coatings useful for extending the service life of plasma treating vessel components under severe conditions, such as those components that are used in semiconductor device manufacture. The invention is useful, for example, in the protection of integrated circuit manufacturing equipment, internal chamber components, and electrostatic chuck manufacture.

### BACKGROUND OF THE INVENTION

Thermal spray coatings can be used for the protection of equipment and components used in erosive and corrosive environments. In a semiconductor wafer manufacturing operation, the interior of a processing chamber is exposed to a variety of erosive and corrosive or reactive environments that can result from corrosive gases or other reactive species, including radicals or byproducts generated from process reactions. For example, a halogen compound such as a chloride, fluoride or bromide is typically used as a treating gas in the manufacture of semiconductors. The halogen compound can be disassociated to atomic chlorine, fluorine or bromine in plasma treating vessels used in semiconductor device manufacture, thereby subjecting the plasma treating vessel to a corrosive environment.

Additionally, in plasma treating vessels used in semiconductor device manufacture, the plasma contributes to the formation of finely divided solid particles and also ion bombardment, both of which can result in erosion damage of the process chamber and component parts.

Also, etch operators are performing more processes that are “dirty” and as such are increasing the severity of the cleaning process required for the process chamber and component parts. When exposed to wet cleaning solutions during cleaning cycles of the process chamber and component parts, byproducts generated from plasma-treating chamber operations, such as chlorides, fluorides and bromides, can react to form corrosive species such as HCl and HF.

Erosion and corrosion resistant measures are needed to ensure process performance and durability of the process chamber and component parts. There is a need in the art to provide improved erosion and corrosion resistant coatings, particularly those of the ceramic oxides, e.g., zirconium oxide (zirconia), yttrium oxide (yttria) and aluminum oxide (alumina), to reduce the level of corrosive attack by process reagents. Particularly, there is a need in the art to improve coating properties to provide corrosion and erosion resistance of thermally sprayed coated equipment and components in plasma treating vessels used in semiconductor device manufacture.

### SUMMARY OF THE INVENTION

This invention relates to a thermal spray coating on a metal or non-metal substrate, said thermal spray coating comprising a partially or fully stabilized ceramic coating, e.g., yttria stabilized zirconia coating, wherein said partially or fully stabilized ceramic coating has sufficiently high thermodynamic phase stability to provide corrosion and/or erosion resistance to said substrate, and wherein said partially or fully stabilized ceramic coating has a coating erosion rate of from about 0 to about 40 microns after 100 hours of exposure to standard CF₄/O₂ based plasma dry cleaning conditions.

This invention also relates to a method for protecting a metal or non-metal substrate, said method comprising applying a thermally sprayed coating to said metal or non-metal substrate, said thermally sprayed coating comprising a partially or fully stabilized ceramic coating, e.g., yttria stabilized zirconia coating, wherein said partially or fully stabilized ceramic coating has sufficiently high thermodynamic phase stability to provide corrosion and/or erosion resistance to said substrate, and wherein said partially or fully stabilized ceramic coating has a coating erosion rate of from about 0 to about 40 microns after 100 hours of exposure to standard CF₄/O₂ based plasma dry cleaning conditions.

This invention further relates to an internal member for a plasma treating vessel comprising a metallic or ceramic substrate and a thermal spray coating on the surface thereof; said thermal spray coating comprising a partially or fully stabilized ceramic coating, e.g., yttria stabilized zirconia coating, wherein said partially or fully stabilized ceramic coating has sufficiently high thermodynamic phase stability to provide corrosion and/or erosion resistance to said substrate, and wherein said partially or fully stabilized ceramic coating has a coating erosion rate of from about 0 to about 40 microns after 100 hours of exposure to standard CF₄/O₂ based plasma dry cleaning conditions.

This invention yet further relates to a method for producing an internal member for a plasma treating vessel, said method comprising applying a thermally sprayed coating to said internal member, said thermally sprayed coating comprising a partially or fully stabilized ceramic coating, e.g., yttria stabilized zirconia coating, wherein said partially or fully stabilized ceramic coating has sufficiently high thermodynamic phase stability to provide corrosion and/or erosion resistance to said internal member, and wherein said partially or fully stabilized ceramic coating has a coating erosion rate of from about 0 to about 40 microns after 100 hours of exposure to standard CF₄/O₂ based plasma dry cleaning conditions.

This invention also relates to a thermal spray coating for a metal or non-metal substrate comprising (i) a thermal spray undercoat layer applied to said substrate comprising a metal oxide, and (ii) a thermal spray topcoat layer applied to said undercoat layer; said thermal spray topcoat layer comprising a partially or fully stabilized ceramic coating, e.g., yttria stabilized zirconia coating, wherein said partially or fully stabilized ceramic coating has sufficiently high thermodynamic phase stability to provide corrosion and/or erosion resistance to said substrate, and wherein said partially or fully stabilized ceramic coating has a coating erosion rate of from about 0 to about 40 microns after 100 hours of exposure to standard CF₄/O₂ based plasma dry cleaning conditions. The undercoat layer can provide appropriate dielectric and thermo-mechanical properties and the topcoat can provide appropriate corrosion and erosion resistance properties and low thermal conductivity desired for semiconductor component applications.

This invention further relates to a method for protecting a metal or non-metal substrate, said method comprising (i) applying a thermal sprayed coating undercoat layer to a metal or non-metal substrate, said undercoat layer comprising a metal oxide, and (ii) applying a thermal sprayed coating topcoat layer to said undercoat layer, said thermal sprayed coating topcoat layer comprising a partially or fully stabilized ceramic coating, e.g., yttria stabilized zirconia coating, wherein said partially or fully stabilized ceramic coating has sufficiently high thermodynamic phase stability to provide corrosion and/or erosion resistance to said substrate, and wherein said partially or fully stabilized ceramic coating has a coating erosion rate of from about 0 to about 40 microns after 100 hours of exposure to standard CF₄/O₂ based plasma dry cleaning conditions.

This invention yet further relates to a internal member for a plasma treating vessel comprising a metallic or ceramic substrate and a thermal spray coating on the surface thereof; said thermal spray coating comprising (i) a thermal spray undercoat layer applied to said substrate comprising a metal oxide, and (ii) a thermal spray topcoat layer applied to said undercoat layer; said thermal spray topcoat layer comprising a partially or fully stabilized ceramic coating, e.g., yttria stabilized zirconia coating, wherein said partially or fully stabilized ceramic coating has sufficiently high thermodynamic phase stability to provide corrosion and/or erosion resistance to said substrate, and wherein said partially or fully stabilized ceramic coating has a coating erosion rate of from about 0 to about 40 microns after 100 hours of exposure to standard CF₄/O₂ based plasma dry cleaning conditions.

This invention also relates to a method for producing an internal member for a plasma treating vessel, said method comprising (i) applying a thermal sprayed coating undercoat layer to said internal member, said undercoat layer comprising a metal oxide, and (ii) applying a thermal sprayed coating topcoat layer to said undercoat layer, said thermal sprayed coating topcoat layer comprising a partially or fully stabilized ceramic coating, e.g., yttria stabilized zirconia coating, wherein said partially or fully stabilized ceramic coating has sufficiently high thermodynamic phase stability to provide corrosion and/or erosion resistance to said internal member, and wherein said partially or fully stabilized ceramic coating has a coating erosion rate of from about 0 to about 40 microns after 100 hours of exposure to standard CF₄/O₂ based plasma dry cleaning conditions.

This invention further relates to a high purity yttria stabilized zirconia powder comprising from about 0 to about 0.15 weight percent impurity oxides, from about 0 to about 2 weight percent hafnia, from about 5 to about 31 weight percent yttria, and the balance zirconia, wherein said high purity yttria stabilized zirconia powder has sufficiently high thermodynamic phase stability to provide corrosion and/or erosion resistance to a coating thermally sprayed from said powder, and wherein said coating has a coating erosion rate of from about 0 to about 40 microns after 100 hours of exposure to standard CF₄/O₂ based plasma dry cleaning conditions.

This invention provides improved erosion and corrosion resistant coatings, particularly those of the ceramic oxides, e.g., zirconia, yttria and alumina, to reduce the level of erosive and corrosive attack by process reagents. Particularly, this invention provides corrosion and erosion resistance to thermally sprayed coated equipment and components in plasma treating vessels used in semiconductor device manufacture, e.g., metal and dielectric etch processes. The coatings also exhibit low particle generation, low metals contamination, and desirable thermal, electrical and adhesion characteristics.

### DETAILED DESCRIPTION OF THE INVENTION

This invention provides a solution to the damage incurred by internal members of the plasma-treating vessels. This invention can minimize damage resulting from aggressive cleaning procedures, e.g., CF₄/O₂ based plasma dry cleaning procedures, used on the internal member components. Because etch operators are performing more processes that are “dirty”, increasing the severity of the cleaning process is required to provide process chamber and component parts suitable for semiconductor applications. For example, when exposed to wet cleaning solutions during cleaning cycles of the process chamber and component parts, byproducts generated from plasma-treating chamber operations, such as chlorides, fluorides and bromides, can react to form corrosive species such as HCl and HF. This invention can minimize damage due to corrosion resulting from the severe cleaning process. The coated internal member components of this invention can withstand these more aggressive cleaning procedures.

This invention can also minimize damage due to chemical corrosion through a halogen gas and also damage due to plasma erosion. When an internal member component is used in an environment containing the halogen excited by the plasma, it is important to prevent plasma erosion damage caused by ion bombardment, which is then effective to prevent the chemical corrosion caused by halogen species. Byproducts generated from the process reactions include halogen compounds such as chlorides, fluorides and bromides. When exposed to atmosphere or wet cleaning solutions during the cleaning cycles, the byproducts can react to form corrosive species such as HCl and HF.

As indicated above, this invention relates to high purity yttria stabilized zirconia powders (and coatings prepared therefrom) comprising from about 0 to about 0.15 weight percent impurity oxides, from about 0 to about 2 weight percent hafnia, from about 5 to about 31 weight percent yttria, and the balance zirconia, wherein said high purity yttria stabilized zirconia powders have sufficiently high thermodynamic phase stability to provide corrosion and/or erosion resistance to a coating thermally sprayed from said powder, and wherein said coating has a coating erosion rate of from about 0 to about 40 microns after 100 hours of exposure to standard CF₄/O₂ based plasma dry cleaning conditions.

The ceramic materials useful in the thermal spray coatings of this invention include, for example, zirconium oxide, yttrium oxide, magnesium oxide (magnesia), cerium oxide (ceria), hafnium oxide (hafnia), aluminum oxide, oxides of Groups 2A to 8B inclusive of the Periodic Table and the Lanthanide elements, or alloys or mixtures or composites thereof. Preferably, the coating materials include zirconium oxide, aluminum oxide, yttrium oxide, cerium oxide, hafnium oxide, gadolinium oxide (gadolinia), ytterbium oxide (ytterbia), or alloys or mixtures or composites thereof. With the above materials, the surfaces of thermally sprayed coatings applied to a plasma treatment vessel or an internal member component used in such a vessel are much more resistant to degradation than bare aluminum, anodized aluminum or sintered aluminum oxide by corrosive gases in combination with radio frequency electric fields which generate gas plasma. Other illustrative coating materials include silicon carbide or boron carbide. With these materials, the surfaces in contact with the etching plasma are those of thermally sprayed coatings applied to a plasma etch chamber or component used in the plasma etch processing of silicon wafers for the manufacture of integrated circuits.

The average particle size of the ceramic powders (particles) useful in this invention is preferably set according to the type of thermal spray device and thermal spraying conditions used during thermal spraying. The ceramic powder particle size (diameter) can range from about 1 to about 150 microns, preferably from about 1 to about 100 microns, more preferably from about 5 to about 75 microns, and most preferably from about 5 to about 50 microns. The average particle size of the powders used to make the ceramic powders useful in this invention is preferably set according to the type of ceramic powder desired. Typically, individual particles useful in preparing the ceramic powders useful in this invention range in size from nanocrystalline size to about 5 microns in size. Submicron particles are preferred for preparing the ceramic powders useful in this invention.

The thermal spraying powders useful in this invention can be produced by conventional methods such as agglomeration (spray dry and sinter or sinter and crush methods) or cast and crush. In a spray dry and sinter method, a slurry is first prepared by mixing a plurality of raw material powders and a suitable dispersion medium. This slurry is then granulated by spray drying, and a coherent powder particle is then formed by sintering the granulated powder. The thermal spraying powder is then obtained by sieving and classifying (if agglomerates are too large, they can be reduced in size by crushing). The sintering temperature during sintering of the granulated powder is preferably 800 to 1600° C. Plasma densification of spray dried and sintered particles and also cast and crush particles can be conducted by conventional methods. Also, atomization of ceramic oxide melts can be conducted by conventional methods.

The thermal spraying powders according to this invention may be produced by another agglomeration technique, sinter and crush method. In the sinter and crush method, a compact is first formed by mixing a plurality of raw material powders followed by compression and then sintered at a temperature between 1200 to 1400° C. The thermal spraying powder is then obtained by crushing and classifying the resulting sintered compact into the appropriate particle size distribution.

The thermal spraying powders according to this invention may also be produced by a cast (melt) and crush method instead of agglomeration. In the melt and crush method, an ingot is first formed by mixing a plurality of raw material powders followed by rapid heating, casting and then cooling. The thermal spraying powder is then obtained by crushing and classifying the resulting ingot.

The thermally sprayed coatings useful in this invention can be made from a ceramic powder comprising ceramic powder particles, wherein the average particle size of the ceramic powder particles can range from about 1 to about 150 microns.

As indicated above, this invention relates to a thermal spray coating on a metal or non-metal substrate, said thermal spray coating comprising a partially or fully stabilized ceramic coating, wherein said partially or fully stabilized ceramic coating has sufficiently high thermodynamic phase stability to provide corrosion and/or erosion resistance to said substrate, and wherein said partially or fully stabilized ceramic coating has a coating erosion rate of from about 0 to about 40 microns after 100 hours of exposure to standard CF₄/O₂ based plasma dry cleaning conditions.

As also indicated above, this invention relates to a thermal spray coating for a metal or non-metal substrate comprising (i) a thermal spray undercoat layer applied to said substrate comprising a metal oxide, and (ii) a thermal spray topcoat layer applied to said undercoat layer; said thermal spray topcoat layer comprising a partially or fully stabilized ceramic coating, wherein said partially or fully stabilized ceramic coating has sufficiently high thermodynamic phase stability to provide corrosion and/or erosion resistance to said substrate, and wherein said partially or fully stabilized ceramic coating has a coating erosion rate of from about 0 to about 40 microns after 100 hours of exposure to standard CF₄/O₂ based plasma dry cleaning conditions.

Illustrative ceramic coatings comprise zirconia and yttria. Preferred ceramic coatings include zirconia partially or fully stabilized by yttria and having a density greater than 88% of the theoretical density. Other ceramic coatings useful in this invention include zirconia partially or fully stabilized by yttria and having a density from about 60% to 85% of the theoretical density, e.g., lower density zirconia partially or fully stabilized by yttria. The ceramic coatings typically have a thickness of from about 0.001 to about 0.1 inches, preferably from about 0.005 to about 0.05 inches, more preferably from about 0.005 to about 0.01 inches. The ceramic coatings typically have a porosity of from about 0.1% to about 12%.

Advantageously, the zirconia-based coating is selected from the group consisting of zirconia, partially stabilized zirconia and fully stabilized zirconia. Most advantageously, this coating is a partially or fully stabilized zirconia, such as calcia, ceria or other rare earth oxides, magnesia and yttria-stabilized zirconia. The most preferred stabilizer is yttria. In particular, the fully stabilized zirconia ZrO₂-15-20 weight percent Y₂O₃ provides excellent resistant to erosion and corrosion. It is believed that higher concentrations of yttria, i.e., 15 to 31 weight percent yttria, stabilizes cubic zirconia whereas lower concentrations of yttria, i.e., about 5 to less than 10 weight percent, stabilizes only tetragonal zirconia.

The partially stabilized zirconia and fully stabilized zirconia coatings of this invention comprise from about 5 to about 31 weight percent yttria (both partially and fully stabilized) and the balance zirconia, preferably from about 15 to about 30 weight percent yttria (fully stabilized) and the balance zirconia, and more preferably preferably from about 15 to about 20 weight percent yttria (fully stabilized) and the balance zirconia.

While not wishing to be bound to any particular theory, it is believed that the increased plasma erosion resistance of the higher yttria concentrations, i.e., 10 to 31 weight percent yttria and balance zirconia, as compared to lower yttria concentrations, i.e., about 5 to less than 10 weight percent and balance zirconia, is due to differences in thermodynamic phase stability and oxygen ion diffusivity as well as differences in the feedstock powders and resulting grain sizes in the coating microstructure and also the surface morphology of the coating.

The zirconia-based ceramic coating advantageously has a density of at least about eighty percent to limit the erosive and corrosive effects of hot acidic gases upon the substrate. Most advantageously, this density is at least about ninety percent.

Erosion and corrosion resistant properties of the thermal spray coatings of this invention can be further improved by blocking or sealing the inter-connected residual micro-porosity inherent in thermally sprayed coatings. Sealers can include hydrocarbon, siloxane, or polyamide based materials with out-gassing properties of <1% TML (total mass loss) and <0.05 CVCM (collected condensible volatile materials), preferably <0.5% TML, <0.02% CVCM. Sealants can also be advantageous in semiconductor device manufacture as sealed coatings on internal chamber components and electrostatics chucks will reduce chamber conditioning time when compared to as-coated or sintered articles. Conventional sealants can be used in the methods of this invention. The sealants can be applied by conventional methods known in the art.

Coatings may be produced using the ceramic powders of this invention by a variety of methods well known in the art. These methods include thermal spray (plasma, HVOF, detonation gun, etc.), electron beam physical vapor deposition (EBPVD), laser cladding; and plasma transferred arc. Thermal spray is a preferred method for deposition of the ceramic powders to form the erosive and corrosive resistant coatings of this invention. The erosion and corrosion resistant coatings of this invention are formed from ceramic powders having the same composition. Such methods may also be used for deposition of the coating layers, e.g., undercoat layer, described below, and for the deposition of continuously graded coatings wherein there are no discrete layers, but the coating is applied as a functional composite. The thermally spray coated internal member is preferably coated with zirconium oxide, yttrium oxide, aluminum oxide or other rare earth oxides.

The ceramic coating can be deposited onto a metal or non-metal substrate using any thermal spray device by conventional methods. Preferred thermal spray methods for depositing the ceramic coatings are plasma spraying including inert gas shrouded plasma spraying and low pressure or vacuum plasma spraying in chambers. Other deposition methods that may be useful in this invention include high velocity oxygen-fuel torch spraying, detonation gun coating and the like. The most preferred method is inert gas shrouded plasma spraying and low pressure or vacuum plasma spraying in chambers. It could also be advantageous to heat treat the ceramic coating using appropriate times and temperatures to achieve a good bond for the ceramic coating to the substrate and a high sintered density of the ceramic coating. Other means of applying a uniform deposit of powder to a substrate in addition to thermal spraying include, for example, electrophoresis, electroplating and slurry deposition.

The method of this invention preferably employs plasma spray methodology. The plasma spraying is suitably carried out using fine agglomerated powder particle sizes, typically having an average agglomerated particle size of less than about 50 microns, preferably less than about 40 microns, and more preferably from about 5 to about 50 microns. Individual particles useful in preparing the agglomerates typically range in size from nanocrystalline size to about 5 microns in size. The plasma medium can be nitrogen, hydrogen, argon, helium or a combination thereof.

The thermal content of the plasma gas stream can be varied by changing the electrical power level, gas flow rates, or gas composition. Argon is usually the base gas, but helium, hydrogen and nitrogen are frequently added. The velocity of the plasma gas stream can also be varied by changing the same parameters.

Variations in gas stream velocity from the plasma spray device can result in variations in particle velocities and hence dwell time of the particle in flight. This affects the time the particle can be heated and accelerated and, hence, its maximum temperature and velocity. Dwell time is also affected by the distance the particle travels between the torch or gun and the surface to be coated.

The specific deposition parameters depend on both the characteristics of the plasma spray device and the materials being deposited. The rate of change or the length of time the parameters are held constant are a function of both the required coating composition, the rate of traverse of the gun or torch relative to the surface being coated, and the size of the part. Thus, a relatively slow rate of change when coating a large part may be the equivalent of a relatively large rate of change when coating a small part.

As indicated above, a suitable thickness for the thermally sprayed coatings of this invention can range from about 0.001 to about 0.1 inches depending on any allowance for dimensional grinding, the particular application and the thickness of any other layers. For typical applications and erosive and corrosive environments, the coating thickness may range from about 0.001 to about 0.05 inches, preferably from about 0.005 to about 0.01 inches, but thicker coatings will be needed to accommodate reduction in final thickness by any abrading procedure. In other words, any such abrading procedure will reduce the final thickness of the coating.

Illustrative metallic and non-metallic internal member substrates include, for example, aluminum and its alloys, typified by aluminum 6061 in the T6 condition and sintered aluminum oxide. Other illustrative substrates include various steels inclusive of stainless steel, nickel, iron and cobalt based alloys, tungsten and tungsten alloy, titanium and titanium alloy, molybdenum and molybdenum alloy, and certain non-oxide sintered ceramics, and the like.

In an embodiment, an internal aluminum member can be anodized prior to applying said thermal spray coating. A few metals can be anodized but aluminum is the most common. Anodization is a reaction product formed in situ by anodic oxidation of the substrate by an electrochemical process. The anodic layer formed by anodization is aluminum oxide which is a ceramic.

The internal member can comprise a substrate, a metal coating applied on the surface thereof as an undercoat, and the thermal spray coating applied on the undercoat as a topcoat. In such a coating, the undercoat can comprise aluminum oxide or a mixture of aluminum oxide and yttrium oxide and the topcoat can be preferably zirconium oxide and yttrium oxide. The undercoat can be applied by a chemical vapor deposition process, a physical vapor deposition process, a thermal spray process or an electrochemical growth process.

In another embodiment, the internal member can comprise a substrate, a metal coating applied on the surface thereof as an undercoat, a middle layer applied on the undercoat, and said thermal spray coating applied on the middle layer as a topcoat. In such a coating, the undercoat can comprise aluminum oxide or a mixture of aluminum oxide and yttrium oxide, the middle layer can comprise aluminum oxide or a mixture of aluminum oxide and yttrium oxide, and the top coat can be preferably yttria stabilized zirconia. The undercoat and the middle layer can be applied by a chemical vapor deposition process, a physical vapor deposition process, a thermal spray process or an electrochemical growth process.

Other suitable metal substrates include, for example, nickel base superalloys, nickel base superalloys containing titanium, cobalt base superalloys, and cobalt base superalloys containing titanium. Preferably, the nickel base superalloys would contain more than 50% by weight nickel and the cobalt base superalloys would contain more than 50% by weight cobalt. Illustrative non-metal substrates include, for example, permissible silicon-containing materials.

As indicated above, this invention relates to a method for protecting a metal or non-metal substrate, said method comprising applying a thermally sprayed coating to said metal or non-metal substrate, said thermally sprayed coating comprising a partially or fully stabilized ceramic coating, wherein said partially or fully stabilized ceramic coating has sufficiently high thermodynamic phase stability to provide corrosion and/or erosion resistance to said substrate, and wherein said partially or fully stabilized ceramic coating has a coating erosion rate of from about 0 to about 40 microns after 100 hours of exposure to standard CF₄/O₂ based plasma dry cleaning conditions.

As also indicated above, this invention relates to a method for producing an internal member for a plasma treating vessel, said method comprising applying a thermally sprayed coating to said internal member, said thermally sprayed coating comprising a partially or fully stabilized ceramic coating, wherein said partially or fully stabilized ceramic coating has sufficiently high thermodynamic phase stability to provide corrosion and/or erosion resistance to said internal member, and wherein said partially or fully stabilized ceramic coating has a coating erosion rate of from about 0 to about 40 microns after 100 hours of exposure to standard CF₄/O₂ based plasma dry cleaning conditions.

As further indicated above, this invention relates to a method for protecting a metal or non-metal substrate, said method comprising (i) applying a thermal sprayed coating undercoat layer to a metal or non-metal substrate, said undercoat layer comprising a metal oxide, and (ii) applying a thermal sprayed coating topcoat layer to said undercoat layer, said thermal sprayed coating topcoat layer comprising a partially or fully stabilized ceramic coating, wherein said partially or fully stabilized ceramic coating has sufficiently high thermodynamic phase stability to provide corrosion and/or erosion resistance to said substrate, and wherein said partially or fully stabilized ceramic coating has a coating erosion rate of from about 0 to about 40 microns after 100 hours of exposure to standard CF₄/O₂ based plasma dry cleaning conditions.

As also indicated above, this invention relates to a method for producing an internal member for a plasma treating vessel, said method comprising (i) applying a thermal sprayed coating undercoat layer to said internal member, said undercoat layer comprising a metal oxide, and (ii) applying a thermal sprayed coating topcoat layer to said undercoat layer, said thermal sprayed coating topcoat layer comprising a partially or fully stabilized ceramic coating, wherein said partially or fully stabilized ceramic coating has sufficiently high thermodynamic phase stability to provide corrosion and/or erosion resistance to said internal member, and wherein said partially or fully stabilized ceramic coating has a coating erosion rate of from about 0 to about 40 microns after 100 hours of exposure to standard CF₄/O₂ based plasma dry cleaning conditions.

The coated internal members of this invention can be prepared by flowing powder through a thermal spraying device that heats and accelerates the powder onto a base (substrate). Upon impact, the heated particle deforms resulting in a thermal sprayed lamella or splat. Overlapping splats make up the coating structure. A plasma spray process useful in this invention is disclosed in U.S. Pat. No. 3,016,447, the disclosure of which is incorporated herein by reference. A detonation process useful in this invention is disclosed in U.S. Pat. Nos. 4,519,840 and 4,626,476, the disclosures of which are incorporated herein by reference, which include coatings containing tungsten carbide cobalt chromium compositions. U.S. Pat. No. 6,503,290, the disclosure of which is incorporated herein by reference, discloses a high velocity oxygen fuel process that may be useful in this invention to coat compositions containing W, C, Co, and Cr. Cold spraying methods known in the art may also be useful in this invention. Typically, such cold spraying methods use liquid helium gas which is expanded through a nozzle and allowed to entrain powder particles. The entrained powder particles are then accelerated to impact upon a suitably positioned workpiece.

In coating the internal members of this invention, the thermal spraying powder is thermally sprayed onto the surface of the internal member, and as a result, a thermal sprayed coating is formed on the surface of the internal member. High-velocity-oxygen-fuel or detonation gun spraying are illustrative methods of thermally spraying the thermal spraying powder. Other coating formation processes include plasma spraying, plasma transfer arc (PTA), or flame spraying. For electronics applications, plasma spraying is preferred for zirconia, yttria and alumina coatings because there is no hydrocarbon combustion and therefore no source of contamination. Plasma spraying uses clean electrical energy. Preferred coatings for thermally spray coated articles of this invention include, for example, zirconium oxide, yttrium oxide, magnesium oxide, cerium oxide, aluminum oxide, hafnium oxide, oxides of Groups 2A to 8B inclusive of the Periodic Table and the Lanthanide elements, or alloys or mixtures or composites thereof.

As indicated above, this invention relates to an internal member for a plasma treating vessel comprising a metallic or ceramic substrate and a thermal spray coating on the surface thereof said thermal spray coating comprising a partially or fully stabilized ceramic coating, wherein said partially or fully stabilized ceramic coating has sufficiently high thermodynamic phase stability to provide corrosion and/or erosion resistance to said substrate, and wherein said partially or fully stabilized ceramic coating has a coating erosion rate of from about 0 to about 40 microns after 100 hours of exposure to standard CF₄/O₂ based plasma dry cleaning conditions.

As also indicated above, this invention relates to a internal member for a plasma treating vessel comprising a metallic or ceramic substrate and a thermal spray coating on the surface thereof; said thermal spray coating comprising (i) a thermal spray undercoat layer applied to said substrate comprising a metal oxide, and (ii) a thermal spray topcoat layer applied to said undercoat layer; said thermal spray topcoat layer comprising a partially or fully stabilized ceramic coating, wherein said partially or fully stabilized ceramic coating has sufficiently high thermodynamic phase stability to provide corrosion and/or erosion resistance to said substrate, and wherein said partially or fully stabilized ceramic coating has a coating erosion rate of from about 0 to about 40 microns after 100 hours of exposure to standard CF₄/O₂ based plasma dry cleaning conditions.

Illustrative internal member components for a plasma treating vessel used in the production of an integrated circuit include, for example, a deposit shield, baffle plate, focus ring, insulator ring, shield ring, bellows cover, electrode, chamber liner, cathode liner, gas distribution plate, electrostatic chucks (for example, the sidewalls of electrostatic chucks), and the like. This invention is generally applicable to components subjected to corrosive environments such as internal member components for plasma treating vessels. This invention provides corrosive barrier systems that are suitable for protecting the surfaces of such internal member components. While the advantages of this invention will be described with reference to internal member components, the teachings of this invention are generally applicable to any component on which a corrosive barrier coating may be used to protect the component from a corrosive environment.

According to this invention, internal member components intended for use in corrosive environments of plasma treating vessels are thermal spray coated with a protective coating layer. The thermal sprayed coated internal member component formed by the method of this invention can have desired corrosion resistance, plasma erosion resistance, and wear resistance.

The coatings of this invention are useful for chemical processing equipment used at low and high temperatures, e.g., in harsh erosive and corrosive environments. In harsh environments, the equipment can react with the material being processed therein. Ceramic materials that are inert towards the chemicals can be used as coatings on the metallic equipment components. The ceramic coatings should be impervious to prevent erosive and corrosive materials from reaching the metallic equipment. A coating which can be inert to such erosive and corrosive materials and prevent the erosive and corrosive materials from reaching the underlying substrate will enable the use of less expensive substrates and extend the life of the equipment components.

The thermal sprayed coatings of this invention show desirable resistance when used in an environment subject to plasma erosion action in a gas atmosphere containing a halogen gas. For example, even when plasma etching operation is continued over a long time, the contamination through particles in the deposition chamber is less and a high quality internal member component can be efficiently produced. By the practice of this invention, the rate of generation of particles in a plasma process chamber can become slower, so that the interval for the cleaning operation becomes longer increasing productivity. As a result, the coated internal members of this invention can be effective in a plasma treating vessel in a semiconductor production apparatus.

Internal members coated with a thermal spray coating of this invention exhibit good erosion resistance. The thermal spray coatings of this invention, i.e., the partially or fully stabilized ceramic coatings, can exhibit a coating erosion rate of from about 0 to about 40 microns after 100 hours of exposure to standard CF₄/O₂ based plasma dry cleaning conditions, preferably a coating erosion rate of from about 0 to about 20 microns after 100 hours of exposure to standard CF₄/O₂ based plasma dry cleaning conditions, and more preferably a coating erosion rate of from about 0 to about 10 microns after 100 hours of exposure to standard CF₄/O₂ based plasma dry cleaning conditions. CF₄/O₂ based plasma dry cleaning conditions are considered more harsh than standard plasma-treating vessel operating conditions. Thus, in comparison with the erosion rates under CF₄/O₂ based plasma dry cleaning conditions, the erosion rates under standard plasma-treating vessel operating conditions are expected to be improved.

The thermal spray coatings of this invention, i.e., the partially or fully stabilized ceramic coatings, in comparison to the corrosion and/or erosion resistance provided to a substrate by a corresponding unstabilized ceramic coating, provide about 25 percent or greater corrosion and/or erosion resistance to the substrate, preferably about 40 percent or greater corrosion and/or erosion resistance to the substrate, and more preferably about 50 percent or greater corrosion and/or erosion resistance to the substrate.

As used herein, “standard CF₄/O₂ based plasma dry cleaning conditions” involves temperatures ranging from about −120° C. to about 400° C. and pressures ranging from about 0.01 ton to about 0.2 ton in the presence of plasma and a gas atmosphere containing a gas comprising a mixture of CF₂ and O₂. As also used herein, “standard plasma-treating vessel operating conditions” involves comparable operating temperature and pressure ranges in the presence of plasma and a gas atmosphere containing a halogen gas. Byproducts generated from the standard process reactions include halogen compounds such as chlorides, fluorides and bromides. When exposed to atmosphere or wet cleaning solutions during the cleaning cycles, the byproducts can react to form corrosive species such as HCl and HF.

It should be apparent to those skilled in the art that this invention may be embodied in many other specific forms without departing from the spirit of scope of the invention.

1. A thermal spray coating on a metal or non-metal substrate, said thermal spray coating comprising a partially or fully stabilized ceramic coating, wherein said partially or fully stabilized ceramic coating has sufficiently high thermodynamic phase stability to provide corrosion and/or erosion resistance to said substrate, and wherein said partially or fully stabilized ceramic coating has a coating erosion rate of from about 0 to about 40 microns after 100 hours of exposure to standard CF₄/O₂ based plasma dry cleaning conditions.

2. The thermal spray coating of claim 1 wherein said partially or fully stabilized ceramic coating has a coating erosion rate of from about 0 to about 20 microns after 100 hours of exposure to standard CF₄/O₂ based plasma dry cleaning conditions.

3. The thermal spray coating of claim 1 wherein, in comparison to the corrosion and/or erosion resistance provided to said substrate by a corresponding unstabilized ceramic coating, said partially or fully stabilized ceramic coating provides about 25 percent or greater corrosion and/or erosion resistance to said substrate.

4. The thermal spray coating of claim 1 which comprises zirconium oxide, yttrium oxide, magnesium oxide, cerium oxide, aluminum oxide, hafnium oxide, oxides of Groups 2A to 8B inclusive of the Periodic Table and the Lanthanide elements, or alloys or mixtures or composites thereof.

5. The thermal spray coating of claim 1 which comprises zirconium oxide, aluminum oxide, yttrium oxide, cerium oxide, hafnium oxide, gadolinium oxide, ytterbium oxide, or alloys or mixtures or composites thereof.

6. The thermal spray coating of claim 1 which comprises silicon carbide or boron carbide.

7. The thermal spray coating of claim 1 wherein said substrate is anodized prior to applying said thermal spray coating.

8. The thermal spray coating of claim 1 wherein said substrate is constructed of aluminum or its alloys or sintered aluminum oxide.

9. The thermal spray coating of claim 1 wherein said substrate comprises an internal member of a plasma treating vessel.

10. The thermal spray coating of claim 9 wherein said internal member is selected from a deposit shield, baffle plate, focus ring, insulator ring, shield ring, bellows cover, electrode, chamber liner, cathode liner, gas distribution plate, and electrostatic chuck.

11. The thermal spray coating of claim 9 wherein the plasma treating vessel is used in the production of an integrated circuit component.

12. The thermal spray coating of claim 1 which is applied by a plasma coating method, a high-velocity oxygen fuel coating method, a detonation coating method or a cold spraying method.

13. The thermal spray coating of claim 1 which comprises a zirconia-based coating selected from zirconia, partially stabilized zirconia and fully stabilized zirconia.

14. The thermal spray coating of claim 1 which comprises yttria or ytterbia stabilized zirconia.

15. The thermal spray coating of claim 1 which comprises from about 10 to about 31 weight percent yttria and the balance zirconia.

16. The thermal spray coating of claim 1 which comprises from about 15 to about 20 weight percent yttria and the balance zirconia.

17. The thermal spray coating of claim 1 which comprises a zirconia-based coating having a density from about 60% to about 85% of the theoretical density.

18. The thermal spray coating of claim 1 which comprises a zirconia-based coating having a porosity from about 0.1% to about 12%.

19. The thermal spray coating of claim 1 wherein the plasma spraying is selected from inert gas shrouded plasma spraying and low pressure or vacuum plasma spraying in chambers.

20. The thermal spray coating of claim 1 which is thermally sprayed from a powder having an average agglomerated particle size of less than about 50 microns.

21. The thermal spray coating of claim 1 which comprises zirconium oxide and yttrium oxide.

22. A metal or non-metal substrate coated with the thermal spray coating of claim 1.

23. A method for protecting a metal or non-metal substrate, said method comprising applying a thermally sprayed coating to said metal or non-metal substrate, said thermally sprayed coating comprising a partially or fully stabilized ceramic coating, wherein said partially or fully stabilized ceramic coating has sufficiently high thermodynamic phase stability to provide corrosion and/or erosion resistance to said substrate, and wherein said partially or fully stabilized ceramic coating has a coating erosion rate of from about 0 to about 40 microns after 100 hours of exposure to standard CF₄/O₂ based plasma dry cleaning conditions.

24. A thermal spray coating for a metal or non-metal substrate comprising (i) a thermal spray undercoat layer applied to said substrate comprising a metal oxide, and (ii) a thermal spray topcoat layer applied to said undercoat layer; said thermal spray topcoat layer comprising a partially or fully stabilized ceramic coating, wherein said partially or fully stabilized ceramic coating has sufficiently high thermodynamic phase stability to provide corrosion and/or erosion resistance to said substrate, and wherein said partially or fully stabilized ceramic coating has a coating erosion rate of from about 0 to about 40 microns after 100 hours of exposure to standard CF₄/O₂ based plasma dry cleaning conditions.

25. A high purity yttria stabilized zirconia powder comprising from about 0 to about 0.15 weight percent impurity oxides, from about 0 to about 2 weight percent hafnia, from about 5 to about 31 weight percent yttria, and the balance zirconia, wherein said high purity yttria stabilized zirconia powder has sufficiently high thermodynamic phase stability to provide corrosion and/or erosion resistance to a coating thermally sprayed from said powder, and wherein said coating has a coating erosion rate of from about 0 to about 40 microns after 100 hours of exposure to standard CF₄/O₂ based plasma dry cleaning conditions.
